(19) United States
(12) Patent Application Publication
(10) Pub. No.: US 2013/0234552 A1
(43) Pub. Date: Sep. 12, 2013

(54) ROTATING DEVICE

(71) Applicant: ALPHANA TECHNOLOGY CO., LTD., Fujieda City (JP)

(72) Inventors: Mitsuo KODAMA, Fujieda City (JP); Taketo NONAKA, Fujieda City (JP); Ryusuke SUGIKI, Fujieda City (JP)

(73) Assignee: ALPHANA TECHNOLOGY CO., LTD., Fujieda City (JP)

(21) Appl. No.: 13/777,677

(22) Filed: Feb. 26, 2013

(30) Foreign Application Priority Data
Feb. 28, 2012 (JP) 2012-040984

(51) Int. Cl. H02K 5/16

(52) U.S. Cl. CPC H02K 5/16
USPC 310/90

(57) ABSTRACT

A rotating device includes a base having a peripheral wall with a fastened top cover, an axial body with one end fixed to the base and another end joined with the top cover, a freely rotatable bearing body with the axial body thereinside, a radial dynamic pressure generating groove in either one of surfaces of the axial body, the axial and bearing bodies facing each other in a radial direction, a lubricating medium in a space between the axial and bearing bodies, a radially outward extending lower flange on the one-end side face of the axial body, and a radially outward extending upper flange on the another-end side face of the axial body, a bearing unit in a space between the upper and lower flanges in an axial direction, a lower rod fastened to the lower flange, and an upper rod encircling the lower rod fastened to the upper flange.

### BACKGROUND OF THE INVENTION

1. Field of the Invention

The present invention relates to a rotating device like a disk drive device, and more specifically, to a rotating device having a shaft fastened to a stationary body.

2. Description of the Related Art

Rotating devices like disk drive devices are becoming compact and increasing the capacity, and loaded in various electronic devices. In particular, loading of hard disk drives that are a kind of the disk drive devices in portable electronic devices, such as a laptop computer and a portable music player, is advancing. Rotating devices like disk drive devices loaded in such portable electronic device need improvement of shock resistance and vibration resistance in order to withstand a shock due to a falling and a vibration at the time of carrying in comparison with the rotating devices loaded in a stationary electronic device like a desktop computer. Conversely, such rotating devices need thinning and reduction in weight in comparison with the rotating devices loaded in the stationary electronic device like a desktop computer. In general, thinning and improvement of shock resistance are in a trade-off relationship.

The inventors of the present invention propose, in JP 2010-261580 A, for example, a rotating device having a shaft fastened to a base and employing a bearing unit that is a fluid dynamic bearing mechanism. According to the disk drive device disclosed in JP 2010-261580 A, a shaft of a fluid dynamic bearing unit has one end directly joined with a base member to form a joined part. A screw hole is formed in another end of the shaft, and a top cover is fixed thereto by a screw. Moreover, another end of the shaft is joined with a flange member to form a joined part. That is, the joined part of the base and the shaft and the joined part of the flange member and the shaft overlap in the axial direction, and thus a relationship is satisfied in which the length in the axial direction of another joined part becomes short when the length in the axial direction of the one joined part is increased under a condition in which the thickness of the rotating device in the axial direction is restricted.

In order to make the rotating device thinner, a technique of reducing the length in the axial direction of the joined part of the base and the shaft is possible. According to the conventional fastened-shaft type motor disclosed in, for example, JP 2010-261580 A, however, when the length in the axial direction of the joined part of the base and the shaft is reduced, since the diameter of that joined part is small, the joining strength decreases. Moreover, when a shock is applied to the rotating device, the joined part of the base and the shaft highly possibly breaks down. That is, in order to make the rotating device thinner, there is a task of enhancing the strength of the joined part of the base and the shaft, thereby suppressing the reduction of the shock-resistance strength.

Moreover, a technique of reducing the dimension in the rotation axis direction of a dynamic pressure generating part is also possible in order to make the rotating device thinner. However, when the dimension in the rotation axis direction of the dynamic pressure generating part is reduced, it results in the reduction of the rigidity of the bearing unit, which may negatively affects the shock resistance and vibration resistance of the motor. Alternatively, such a motor includes a stationary body and a rotating body, and the stationary body and the rotating body may have respective faces in the rotation axis direction contacting with each other when a shock like a falling is applied. When the stationary body and the rotating body contact with each other, it becomes a cause of a breakdown in the worst case.

Alternatively, according to the conventional fastened-shaft type motor disclosed in JP 2010-261580 A, a top cover is formed with a hole at the center part thereof, and a screw passing all the way through this hole is engaged and joined with the screw hole in the end of a shaft of a fluid dynamic bearing unit. Accordingly, since the screw hole is formed in another end of the shaft, the thickness of such an area where the screw hole is formed is reduced in the radial direction, and thus the strength may be reduced. In general, when such a rotating device is made thin, the dimension in the axial direction of the shaft is reduced. When the shaft becomes short with the dimension of the screw hole in the axial direction being constant, the ratio of the area of the shaft where the screw hole is formed in the axial direction increases. When a screw is engaged with the screw hole of the shaft having the ratio of the screw-hole formed area high, compression stress that compresses the shaft in the axial direction is applied to the shaft. This compression stress causes the shaft to expand from the outer circumferential surface thereof, and to be deformed non-uniformly. The caused deformation may negatively affect the fluid dynamic bearing unit provided around the outer circumferential surface of the shaft. For example, the gap of the fluid dynamic bearing unit may become uneven, and thus the stationary body and the rotating body may have circumferential surfaces contacting with each other. When the stationary body and the rotating body contact with each other, the contacting part is worn, which reduces the lifetime of the rotating device. Moreover, when the stationary body and the rotating body contact with each other, it becomes a cause of a breakdown of the rotating device in the worst case. Conversely, when the dimension in the axial direction of the screw hole is reduced, the engaged area between the screw and the screw hole becomes small, and thus the joining strength between the screw and the screw hole decreases. According to such a rotating device, when a shock like a falling is applied, the possibility that the joined part of the screw and the screw hole comes loose increases. When the joined part of the screw and the screw hole becomes loose, it becomes a cause of a breakdown in the worst case. Hence, there is also a task of joining the shaft with the top cover without providing a screw hole to be engaged with a screw in another end of the shaft.

The same is true of not only the rotating devices loaded in portable electronic devices, but also electronic devices of other types, in particular, rotating devices having a shaft fastened to a stationary body and employing a fluid dynamic bearing unit.

The present invention has been made in view of such circumstances, and it is an object of the present invention to provide a rotating device which is an improvement of conventional rotating devices and which enhances the shock resistance of a part forming a fluid dynamic bearing unit, thereby facilitating a thinning.

### SUMMARY OF THE INVENTION

A first aspect of the present invention relates to a rotating device. This rotating device includes: a base including a peripheral wall provided at a peripheral edge of the base; a top cover fastened to the peripheral wall; an axial body having one end fixedly provided to the base, and having another end joined with the top cover; a bearing body which retains thereinside the axial body and which is supported in a freely rotatable manner relative to the base; a radial dynamic pressure generating groove provided in either one of surfaces of the axial body and the bearing body facing with each other in a radial direction; a lubricating medium present in a space between the axial body and the bearing body; a lower flange provided on a side face of the axial body at the one-end side, and extending outwardly of the radial direction; and an upper flange provided on a side face of the axial body at the another-end side, and extending outwardly of the radial direction. The bearing unit is placed in a space between the upper flange and the lower flange in an axial direction, and the axial body includes a lower rod to which the lower flange is fastened, and an upper rod which encircles the lower rod and to which the upper flange is fastened.

A second aspect of the present invention also relates to a rotating device. This rotating device includes: a base including a peripheral wall provided at a peripheral edge of the base; a top cover fastened to the peripheral wall; an axial body having one end fixedly provided to the base, and having another end joined with the top cover; a bearing body which retains thereinside the axial body and which is supported in a freely rotatable manner relative to the base; a radial dynamic pressure generating groove provided in either one of surfaces of the axial body and the bearing body facing with each other in a radial direction; a lubricating medium present in a space between the axial body and the bearing body; a lower flange provided on a side face of the axial body at the one-end side, and extending outwardly of the radial direction; and an upper flange provided on a side face of the axial body at the another-end side, and extending outwardly of the radial direction. The bearing unit is placed in a space between the upper flange and the lower flange in an axial direction, the axial body includes a lower rod to which the lower flange is fastened, and an upper rod which encircles the lower rod and to which the upper flange is fastened, and the axial body further includes an axial-body convexity engaged with an engagement hole provided in the top cover.

A third aspect of the present invention also relates to a rotating device. This rotating device includes: a base including a peripheral wall provided at a peripheral edge of the base; a top cover fastened to the peripheral wall; an axial body having one end fixedly provided to the base, and having another end joined with the top cover; a bearing body which retains thereinside the axial body and which is supported in a freely rotatable manner relative to the base; a radial dynamic pressure generating groove provided in either one of surfaces of the axial body and the bearing body facing with each other in a radial direction; and a lubricating medium present in a space between the axial body and the bearing body. The axial body includes an axial-body convexity engaged with an engagement hole provided in the top cover.

Any combination of the above-explained components and replacement of the component of the present invention and the expression thereof between a method, a device, and a system, etc., are also advantageous as an aspect of the present invention.

According to the present invention, it becomes possible to provide a rotating device which enhances the shock resistance of a part forming a fluid dynamic bearing unit, thereby facilitating a thinning.

### BRIEF DESCRIPTION OF THE DRAWINGS

FIG. 1 is an exploded perspective view illustrating a rotating device according to a first embodiment;

FIG. 2 is a cross-sectional view taken along a line A-A in FIG. 1;

FIG. 3 is an enlarged exploded cross-sectional view illustrating a fluid dynamic bearing unit in FIG. 2 exploded so as to illustrate the major components in an enlarged manner;

FIG. 4 is an enlarged cross-sectional view illustrating a periphery of an area where a lubricant in FIG. 2 is present in an enlarged manner;

FIG. 5 is an enlarged cross-sectional view illustrating the rotating device in FIG. 2 with a top cover attached thereto;

FIG. 6 is an enlarged cross-sectional view illustrating a joined part of the top cover in FIG. 5 with an upper shaft member;

FIG. 7 is an enlarged cross-sectional view illustrating a joined part of a top cover of a rotating device and an upper shaft member thereof according to a first modified example;

FIG. 8 is an enlarged cross-sectional view illustrating a joined part of a top cover of a rotating device and an upper shaft member thereof according to a second modified example;

FIG. 9 is an enlarged cross-sectional view illustrating a joined part of a top cover of a rotating device and an upper shaft member thereof according to a third modified example;

FIG. 10 is an enlarged cross-sectional view illustrating a joined part of a top cover of a rotating device and an upper shaft member thereof according to a fourth modified example;

FIG. 11 is an enlarged cross-sectional view illustrating a joined part of a top cover of a rotating device and an upper shaft member thereof according to a fifth modified example; and

FIG. 12 is an enlarged cross-sectional view illustrating a joined part of a top cover of a rotating device and an upper shaft member thereof according to a sixth modified example;

### DETAILED DESCRIPTION OF THE PREFERRED EMBODIMENTS

Preferred embodiments of the present invention will be explained below with reference to the accompanying drawings. The same or equivalent component illustrated in the respective figures will be denoted by the same reference numeral, and the duplicated explanation thereof will be omitted accordingly. The dimension of a component in each figure is indicated in an enlarged or scale-down manner as needed in order to facilitate understanding to the present invention. A part of a component not important to explain an embodiment of the present invention in each figure will be omitted.

The rotating device according to an embodiment is suitably used as a disk drive device like a hard disk drive as an example on which a magnetic recording disk magnetically recording data is to be mounted and which rotates and drives such a magnetic recording disk. In particular, it is suitably used as a fastened-shaft disk drive device which has a shaft fastened to a base and which has a hub rotating relative to the shaft. For example, this rotating device includes a rotating body that is attached to a stationary body in a freely rotatable manner through a bearing unit. For example, the rotating body includes a mount which can mount a drive-target medium like the magnetic recording disk. For example, the bearing unit includes a radial bearing unit formed in either one of the stationary body and the rotating body. For example, the bearing unit includes a thrust bearing unit formed in either one of the stationary body and the rotating body. For example, the thrust bearing unit is located outwardly of the radial bearing unit in the radial direction. For example, the radial bearing unit and the thrust bearing unit may produce dynamic pressure to a lubricating medium. For example, the radial bearing unit and the thrust bearing unit may include the lubricating medium. For example, the rotating device may include a rotating-driving unit that applies rotation torque to the rotating body. For example, the rotating-driving unit may be a brush-less spindle motor. For example, this rotating-driving unit may include coils and a magnet.

### Embodiment

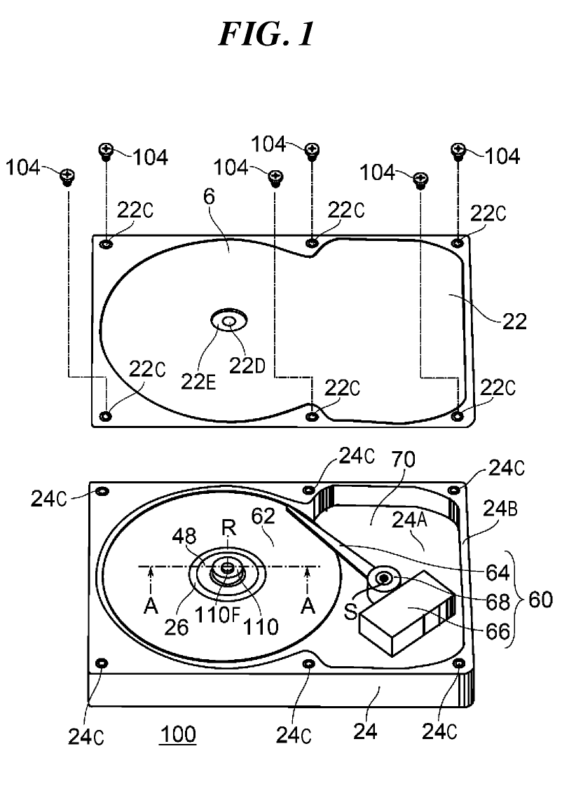

FIG. 1 is a perspective view illustrating a rotating device 100 according to an embodiment of the present invention. FIG. 1 illustrates a condition in which a top cover 22 is detached in order to facilitate understanding to the present invention. The rotating device 100 includes a base 24, an upper shaft member 110, a hub 26, a magnetic recording disk 62, a data reader/writer 60, the top cover 22, and for example, six screws 104.

In the following explanation it is defined that a side where the hub 26 is mounted on the base 24 is an upper side. Moreover, a direction along a rotation axis R of a rotating body, an arbitrary direction passing through the rotation axis R on a plane orthogonal to the rotation axis R, and an arbitrary direction on that plane are defined as an axial direction, a radial direction, and a planar direction, respectively.

The magnetic recording disk 62 is, for example, a 2.5-inch magnetic recording disk formed of glass and having a diameter of 65 mm. The magnetic recording disk 62 has a center hole with a diameter of, for example, 20 mm, and has a thickness of, for example, 0.65 mm. The hub 26 carries, for example, one magnetic recording disk 62. The magnetic recording disk 62 is fastened to the hub 26 by, for example, unillustrated clamper. The magnetic recording disk 62 may be held between the clamper and the hub 26. The clamper may be fastened by, for example, engaging the inner circumferential surface with a circumferential groove 26G of the hub 26 to be discussed later.

The base 24 is formed by performing die-cast molding on an aluminum alloy. The base 24 includes a bottom plate 24A that forms the bottom of the rotating device 100, and an outer peripheral wall 24B formed along the outer circumference of the bottom plate 24A so as to surround an area where the magnetic recording disk 62 is to be mounted. The outer peripheral wall 24B has, for example, six screw holes 24C provided in the top face.

The data reader/writer 60 includes a recording/playing head (unillustrated), a swing arm 64, a voice coil motor 66, and a pivot assembly 68. The recording/playing head is attached to the tip of the swing arm 64, records data in the magnetic recording disk 62, or reads the data therefrom. The pivot assembly 68 supports the swing arm 64 in a swingable manner to the base 24 around a head rotating shaft S. The voice coil motor 66 allows the swing arm 64 to swing around the head rotating shaft S to move the recording/playing head to a desired location over the top face of the magnetic recording disk 62. The voice coil motor 66 and the pivot assembly 68 are configured by a conventionally well-known technology of controlling the position of a head.

The top cover 22 is a thin plate formed in a substantially rectangular shape, and has, for example, six screw through-holes 22C provided at the periphery of the top cover 22, a cover recess 22E, and an engagement hole 22D provided at the center of the cover recess 22E. The top cover 22 is formed by, for example, pressing an aluminum plate or an iron-steel plate into a predetermined shape. A surface processing like plating may be applied on the top cover 22 in order to suppress corrosion. The top cover 22 is fastened to the top face of the outer peripheral wall 24B of the base 24 by, for example, the six screws 104. The six screws 104 correspond to the six screw holes 24C, respectively. In particular, the top cover 22 and the top face of the outer peripheral wall 24B are fastened with each other so as to suppress a leak into the interior of the rotating device 100 from the joined portion of the top cover 22 and the top face of the outer peripheral wall 24B. The interior of the rotating device 100 is, more specifically, a clean space 70 surrounded by the bottom plate 24A of the base 24, the outer peripheral wall 24B of the base 24, and the top cover 22. This clean space 70 is designed so as to be fully sealed, i.e., so as not to have a leak-in from the exterior and a leak-out to the exterior. The clean space 70 is filled with clean air having particles eliminated. Hence, foreign materials like the particles are prevented from sticking to the magnetic recording disk 62, thereby improving the reliability of the operation of the rotating device 100. The engagement hole 22D of the top cover 22 is engaged and joined with a cylindrical convexity 110F of the upper shaft member 110.

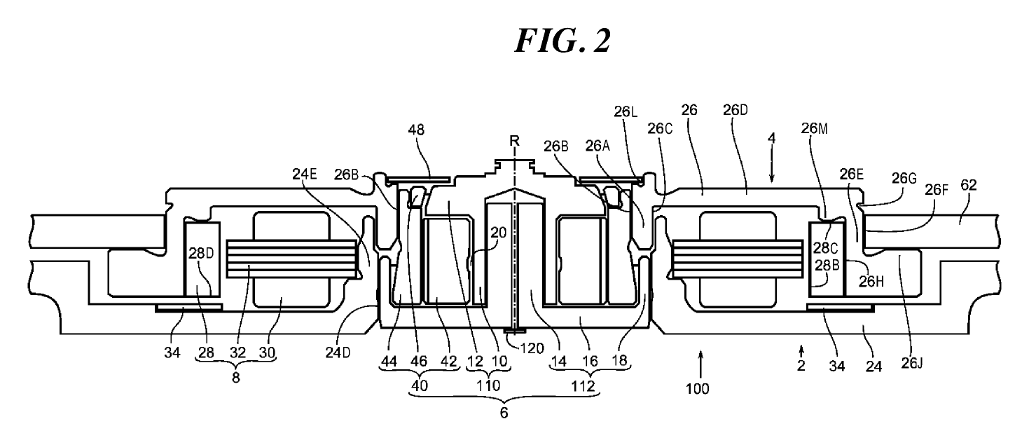

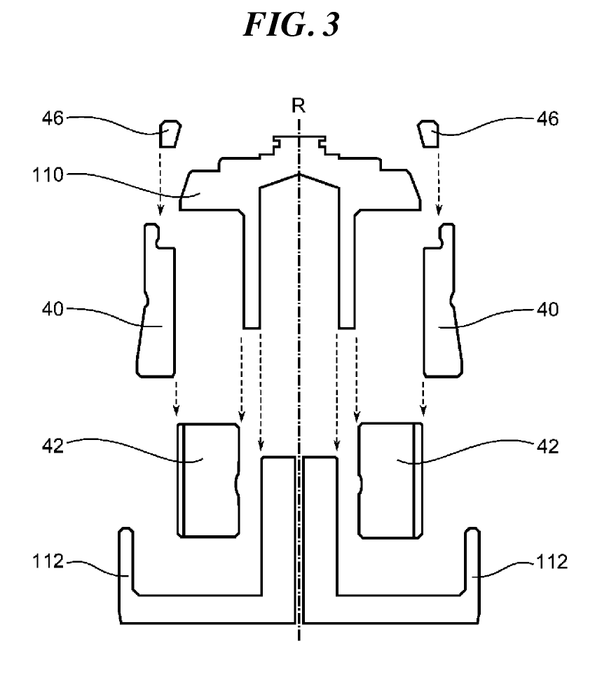

FIG. 2 is a cross-sectional view taken along a line A-A in FIG. 1. FIG. 3 is an enlarged exploded cross-sectional view illustrating the major components of a fluid dynamic bearing unit in an enlarged manner by exploding the fluid dynamic bearing unit illustrated in FIG. 2. FIGS. 2 and 3 are symmetrical along the rotation axis R, and either right or left reference numeral for the same component will be omitted in some cases in the figures.

With reference to FIG. 2, a stationary body 2 includes the upper shaft member 110, a lower shaft member 112, a stator core 32, coils 30, and a magnetic ring 34. The upper shaft member 110 includes an upper rod 10 and an upper flange 12. The lower shaft member 112 includes a lower rod 14, a lower flange 16, and a flange encircling member 18.

A rotating body 4 includes a shaft encircling member 40, a cap 48, and a cylindrical magnet 28. A lubricant 20 is continuously present in several portions between the rotating body 4 and the stationary body 2. The shaft encircling member 40 includes a sleeve 42, a cylindrical member 44, and a ring member 46.

The base 24 is formed with an opening 24D around the rotation axis R of the rotating body 4, and includes an annular protrusion 24E encircling the opening 24D. The protrusion 24E protrudes toward the hub 26 from the upper face of the base 24.

The stator core 32 includes an annular part and, for example, 12 salient poles running outwardly of the radial direction from the annular part, and is fastened to, for example, an outer circumferential surface of the protrusion 24E at the upper-surface side of the base 24. The stator core 32 can be joined with the base 24 by press-fitting, bonding or a combination thereof. The stator core 32 is formed by, for example, laminating five electromagnetic steel sheets each with a thickness of 0.2 mm and joining those sheets together by caulking. A skin layer is provided on the surface of the stator core 32. Insulation painting, such as electrodeposition coating or a power coating, is applied on the surface of the stator core 32. The coil 30 is wound around each salient pole of the stator core 32. When, for example, a three-phase substantially sinusoidal waveform drive current is caused to flow through the coils 30, field magnetic field is produced along the respective salient poles.

The magnetic ring 34 is coaxial with the magnet 28 along the rotation axis R, and is firmly fastened to the upper face of the base 24 by, for example, bonding, caulking or a combination thereof. The magnetic ring 34 is in a hollow ring shape that is thin in the axial direction, and is formed by pressing, for example, a ferrous sheet with soft magnetism. The magnetic ring 34 has an area facing with a bottom face 28D of the magnet 28 in a non-contact manner therewith in the axial direction, and applies downward suction force to the magnet 28. This structure suppresses a floating of the rotating body 4 in the axial direction when the rotating body 4 is rotating.

The hub 26 includes a hollow first annular part 26A, a disk part 26D extending outwardly of the radial direction from an outer circumferential surface 26C of the first annular part 26A, a second annular part 26E extending downwardly of the axial direction from the outer circumference of the disk part 26D, and a mount part 26J extending outwardly of the radial direction from a lower outer circumferential surface 26F of the second annular part 26E. The hub 26 is formed in a substantially cup shape. The first annular part 26A, the disk part 26D, the second annular part 26E, and the mount part 26J are formed coaxially with each other along the rotation axis R. The first annular part 26A, the disk part 26d, the second annular part 26E, and the mount part 26J are formed together as a single piece. Any part may be formed separately and joined with the other parts. The hub 26 is formed of a ferrous material with soft magnetism like SUS 430F. The outer circumferential surface 26F of the second annular part 26E of the hub 26 is engaged with the inner circumferential surface of the magnetic recording disk 62 in a doughnut shape. The magnetic recording disk 62 is to be mounted on the top of the mount part 26J of the hub 26. The circumferential groove 26G recessed inwardly of the radial direction is formed annularly in the outer circumferential surface 26F of the second annular part 26E. The circumferential groove 26G is located above the top face of the magnetic recording disk 62 in the axial direction when the magnetic recording disk 62 is mounted on the hub 26. For example, an inner circumference of the clamper may be fitted and fastened to the circumferential groove 26G. A protrusion 26M protruding downwardly of the axial direction is provided on the lower face of the disk part 26D at the outer circumferential side. A recess 261 recessed outwardly of the radial direction is provided annularly at the upper part of an inner circumferential surface 26B of the first annular part 26A.

The magnet 28 is in a hollow ring shape, and has an outer circumferential surface fastened to an inner circumferential surface 26H of the hub 26 by, for example, bonding. An upper face 28C contacts the protrusion 26M of the hub 26. 16 drive magnetic poles are provided at an inner circumferential surface 28B in the circumferential direction by magnetization. The magnet 28 is formed of a material containing, for example, neodymium, iron, or boron. The magnet 28 may contain a resin at a predetermined percentage. The magnet 28 may be formed of a material containing a ferrite magnetic material, or may be formed by laminating a layer containing a ferrite magnetic material and a layer containing a rare-earth material like neodymium. A skin layer is provided on the surface of the magnetic layer of the magnet 28. For example, electrodeposition coating or spray painting is applied on the surface of the magnet 28. The provided skin layer suppresses an oxidization of the magnet, or suppresses a peeling of the surface of the magnet.

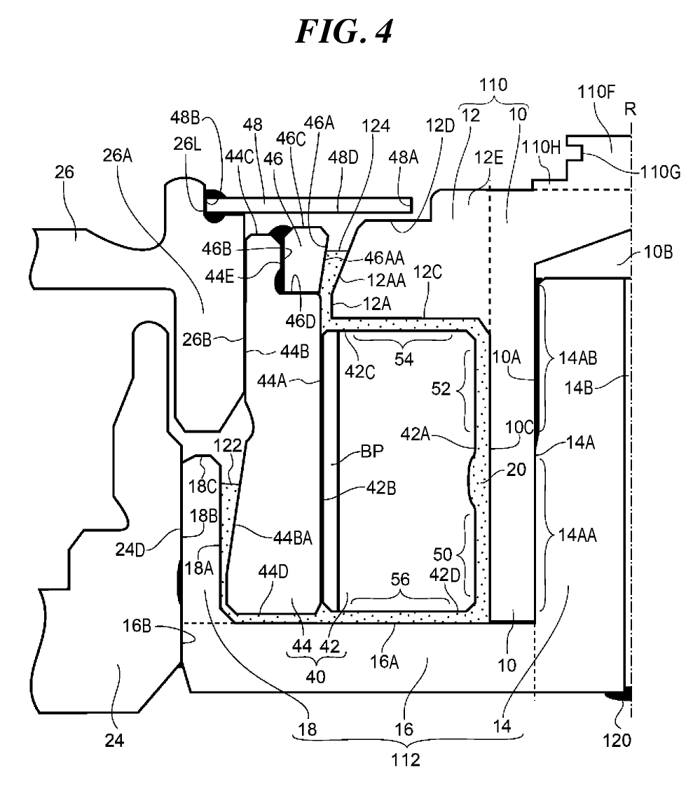

An explanation will be given of the fluid dynamic bearing unit with reference to FIG. 4. FIG. 4 is an enlarged cross-sectional view illustrating the periphery of an area where the lubricant 20 is present in FIG. 2 in an enlarged manner. FIG. 4 illustrates only the left part relative to the rotation axis R.

The lower shaft member 112 includes a lower rod 14 in a rod shape having a through-hole 14B formed in the center thereof, a lower flange 16 in a disk shape extending outwardly of the radial direction from the lower end of an outer circumferential surface 14A of the lower rod 14, and a flange encircling member 18 in a cylindrical shape protruding upwardly of the axial direction from the outer peripheral edge of the lower flange 16. For example, the lower shaft member 112 has the lower rod 14, the lower flange 16, and the flange encircling member 18 formed together as a single piece. In this case, the production error of the lower shaft member 112 can be reduced, and the labor work for joining those members can be eliminated. Alternatively, the lower shaft member 112 can be prevented from being deformed by a shock and a load. For example, the lower shaft member 112 is formed by cutting and machining a metallic material like SUS 303. The lower shaft member 112 may be formed of other materials like a resin, and may be formed by other techniques, such as pressing and molding. The lower shaft member 112 has an outer circumferential surface 18B of the flange encircling member 18 and an outer circumferential surface 16B of the lower flange 16 bonded to the inner circumferential surface of the opening 24D, thereby being fastened to the base 24. The lower rod 14 has a passage cover 120 that covers the lower end of the through-hole 14B. For example, the passage cover 120 is formed by applying a sealant around the lower end of the through-hole 14B and the edge thereof, and letting such a sealant to be cured. The passage cover 120 may be formed by bonding and fastening a sheet formed of, for example, a metallic material or a resin material. For example, an upper end 18C of the flange encircling member 18 is located at or above an area where a first dynamic pressure generating groove 50 to be discussed later is provided in the axial direction. This structure increases the volume of a space between an inner circumferential surface 18A of the flange encircling member 18 and an outer circumferential surface of the shaft encircling member 40 to be discussed later, thereby increasing the volume of the retainable lubricant 20. The increase of the retained lubricant 20 reduces the possibility that a failure occurs due to the lack of the lubricant 20.

The upper shaft member 110 includes an upper rod 10 in a rod shape having a retainer hole 10A formed in the center thereof and retaining the lower rod 14, and an upper flange 12 in a substantially disk shape extending outwardly of the radial direction from the upper end of an outer circumferential surface 10C of the upper rod 10. The upper shaft member 110 includes the cylindrical convexity 110F at an upper end of the upper rod 10 and protruding in a cylindrical shape upwardly of the axial direction. For example, the upper shaft member 110 has the upper rod 10, the upper flange 12, and the cylindrical convexity 110F formed together as a single piece. For example, the upper shaft member 110 may have the upper rod 10 and the cylindrical convexity 110F formed together and have the upper flange 12 formed separately but joined together. For example, the upper shaft member 110 is formed by cutting and machining a ferrous material like SUS 420 J2. For example, the upper shaft member 110 may be quenched in order to increase the hardness. For example, the upper shaft member 110 may have an outer circumferential surface 10C of the upper rod 10 and a lower face 12C of the upper flange 12 polished in order to enhance the dimensional precision. The upper shaft member 110 may be formed of other materials like a resin, and may be formed by other techniques, such as pressing and molding. The upper shaft member 110 has an upper end fastened to the top cover 22 through a method to be discussed later. The lower rod 14 is encircled by and fastened to the upper rod 10. For example, the lower rod 14 has the outer circumferential surface 14A fastened to the retainer hole 10A by a combination technique of bonding and press-fitting. In FIG. 4, a lower part of the outer circumferential surface 14A is defined as a press-fit surface 14AA, while a bonding surface 14AB having a smaller diameter than the press-fit surface 14AA is provided above the press-fit surface 14AA. A bond of, for example, anaerobic is present between the retainer hole 10A and the bonding surface 14AB.

As will be discussed later, the cylindrical convexity 110F is fitted in and bonded to the engagement hole 22D of the top cover 22, and thus the upper shaft member 110 is fastened to the top cover 22. Moreover, the top cover 22 is fastened to the base 24. According to the rotating device of this type having both ends of the shaft fastened to a chassis including the base 24 and the top cover 22, among the fastened-shaft rotating devices, the shock resistance of the rotating device and the vibration resistance thereof can be enhanced.

The upper end of the upper shaft member 110 may be fastened to the top cover 22 by other techniques than bonding, such as caulking and welding. Since no threaded screw hole to which a screw is fastened is formed in the upper end of the upper shaft member 110, a deformation of the outer circumferential surface of the upper rod 10 that occurs in the case of a structure in which a screw is engaged with a screw hole can be suppressed.

The upper rod 10 has a gas reservoir 10B provided at an upper end area of the retainer hole 10A and reserving a gas. The gas reservoir 10B is formed as a space in a substantially conical or cylindrical shape. The gas reservoir 10B is in communication with the through-hole 14B of the lower rod 14. When an uncured bond is present between the retainer hole 10A and the outer circumferential surface 14A, this bond is let cured while producing a gas of contained volatile components. However, by providing the gas reservoir 10B, the volatile component gas of the bond is efficiently discharged to the exterior through the gas reservoir 10B and the through-hole 14B. This results in a reduction of a curing time of the bond, and a reduction of a labor hour. Moreover, the passage cover 120 is provided so as to block off the through-hole 14B after a predetermined time has elapsed since such a work completes. This reduces the possibility of a leak-in of foreign materials from the through-hole 14B, the gas reservoir 10B, and the space between the upper rod 10 and the lower rod 14 to the region where the lubricant 20 is present. Moreover, in a labor work of fitting the lower rod 14 into the retainer hole 10A, air in the retainer hole 10A is discharged to the exterior through the gas reservoir 10B and the through-hole 14B, the efficiency of the fitting work improves.

The upper flange 12 includes an inclined surface 12AA provided at an outer circumferential surface 12A and having a distance in the radial direction from the rotation axis R becoming large as becoming close to the base 24. The upper flange 12 has the lower face 12C facing with an upper face 42C of the sleeve 42 of the shaft encircling member 40 to be discussed later with a gap in the axial direction. The upper flange 12 includes a terrace 12D extending inwardly of the radial direction from the upper end of the outer circumferential surface 12A, and an uplift 12E raised upwardly of the axial direction in a substantially cylindrical shape from the internal end of the terrace 12D. The cylindrical convexity 110F protrudes upwardly of the axial direction from the middle part of the uplift 12E. The cylindrical convexity 110F includes a circumferential recess 110G provided around the outer circumferential surface of the cylindrical convexity 110F. A seat 110H with which a lower surface of the top cover 22 contacts and which extends outwardly of the radial direction is provided around the cylindrical convexity 110F.

The shaft encircling member 40 encircles the upper rod 10 with a gap, and is rotatable relative to the upper rod 10. The shaft encircling member 40 is present between the upper flange 12 and the lower flange 16 with respective gaps. The shaft encircling member 40 is encircled by and fastened to the hub 26. The shaft encircling member 40 is encircled by the flange encircling member 18 of the lower shaft member 112 with a gap. According to such a structure, the hub 26 is supported in a rotatable manner relative to the base 24.

The shaft encircling member 40 includes the substantially cylindrical sleeve 42 that encircles the upper rod 10, a cylindrical member 44 in a substantially cylindrical shape that encircles and is joined with the sleeve 42, and a ring member 46 in a ring shape that is joined with an upper end part of the cylindrical member 44. The sleeve 42 and the cylindrical member 44 are each formed by, for example, cutting and machining a metallic material like brass, and applying electroless nickel plating on the surface thereof. The sleeve 42 and the cylindrical member 44 may be formed of other materials like stainless steel. For example, the sleeve 42 is joined with the cylindrical member 44 by interference fitting like press-fitting or bonding. The sleeve 42 and the cylindrical member 44 may be formed together as a single piece.

The sleeve 42 is in a substantially hollow cylindrical shape, and includes an inner circumferential surface 42A, an outer circumferential surface 42B, the upper face 42C, and a lower face 42D. The sleeve 42 has the inner circumferential surface 42A encircling the upper rod 10 with a gap. The sleeve 42 has the first dynamic pressure generating groove 50 and a second dynamic pressure generating groove 52 for generating radial dynamic pressure and provided in areas of the inner circumferential surface 42a facing with the outer circumferential surface 10C of the upper rod 10 in the radial direction. The second dynamic pressure generating groove 52 is provided above the first dynamic pressure generating groove 50 so as to be distant therefrom. The first and second dynamic pressure generating grooves 50 and 52 may be provided in the outer circumferential surface 10C of the upper rod 10 instead of the sleeve 42.

A third dynamic pressure generating groove 54 for generating thrust dynamic pressure is provided in an area of the upper face 42C of the sleeve 42 facing with the upper flange 12 in the axial direction. The third dynamic pressure generating groove 54 may be provided in an area of the lower face 12C of the upper flange 12 facing with the sleeve 42 in the axial direction instead of the sleeve 42. A fourth dynamic pressure generating groove 56 for generating thrust dynamic pressure is provided in an area of the lower face 42D of the sleeve 42 facing with the lower flange 16 in the axial direction. The fourth dynamic pressure generating groove 56 may be provided in an area of an upper face 16A of the lower flange 16 facing with the sleeve 42 in the axial direction instead of the sleeve 42.

For example, the first and second dynamic pressure generating grooves 50 and 52 are each formed in a herringbone shape. The first and second dynamic pressure generating grooves 50 and 52 may be in other shapes like a spiral shape. For example, the third and fourth dynamic pressure generating grooves 54 and 56 are each formed in a herringbone shape. The third and fourth dynamic pressure generating grooves 54 and 56 may be formed in other shapes like a spiral shape. The first, second, third and fourth dynamic pressure generating grooves 50, 52, 54, and 56 are formed by, for example, pressing, ball-rolling, etching, and cutting and machining. Those dynamic pressure generating grooves may be formed by different techniques from each other.

The cylindrical member 44 is in a substantially hollow cylindrical shape, and includes an inner circumferential surface 44A, an outer circumferential surface 44B, an upper face 44C, a lower face 44D, and a recess 44E provided annularly at the upper end side of the inner circumferential surface 44A so as to be concaved outwardly of the radial direction. The inner circumferential surface 44A is joined with the sleeve 42. An upper part of the outer circumferential surface 44B is joined with an inner circumferential surface 26B of the first annular part 26A of the hub 26. A part of the outer circumferential surface 44B below the area joined with the hub 26 is encircled by the flange encircling member 18 with a gap. The outer circumferential surface 44B includes an inclined surface 44BA provided at an area facing with the inner circumferential surface 18A of the flange encircling member 18 in the radial direction and having a radius becoming small as coming close to the upper end of the outer circumferential surface 44B. A gap between the inclined surface 44BA and the inner circumferential surface 18A gradually becomes widespread toward the upper space in the axial direction. The inclined surface 44BA and the inner circumferential surface 18A contact a first air-liquid interface 122 of the lubricant 20 to be discussed later, and form a capillary seal that prevents the lubricant 20 from being splashed by capillary force. For example, the first air-liquid interface 122 is located at or above the area where the first dynamic pressure generating groove 50 is disposed in the axial direction. This structure enables the rotating device 1 to retain a larger amount of lubricant 20, thereby reducing the possibility of a breakdown due to the lack of the lubricant 20. For example, the first air-liquid interface 122 is provided outwardly of the third and fourth dynamic pressure generating grooves 54 and 56 in the radial direction.

The ring member 46 is in a hollow ring shape, and includes an inner circumferential surface 46A, an outer circumferential surface 46B, an upper face 46C, and a lower face 46D. The ring member 46 is formed by, for example, cutting and machining a stainless-steel material like SUS 303 or SUS 430. The ring member 46 has the outer circumferential surface 46B and the lower face 46D fitted in the recess 44E of the cylindrical member 44, and bonded and fastened thereto. The ring member 46 includes an inclined surface 46AA provided at the inner circumferential surface 46A and having a diameter that becomes small as coming close to the upper end of the inner circumferential surface 46A. The inclined surface 46AA of the ring member 46 and the inclined surface 12AA of the upper flange 12 contact a second air-liquid interface 124 of the lubricant 20 to be discussed later, and form a capillary seal that prevents the lubricant 20 from being splashed by capillary force.

The cap 48 is a hollow ring shape thin in the axial direction, and includes an inner circumferential surface 48A, an outer circumferential surface 48B, an upper face and a lower face 48D. For example, the cap 48 is formed by cutting and machining a stainless-steel material like SUS 303 or SUS 430. The cap 48 may be formed of other metallic materials or resin materials or may be formed through other techniques, such as pressing and molding. The cap 48 has the outer circumferential surface 48B fitted in the recess 261 of the inner circumferential surface 26B of the first annular part 26A of the hub 26, and bonded and joined thereto. The cap 48 has the lower face 48D covering the second air-liquid interface 124. The cap 48 has the inner circumferential surface 48A encircling the side face of the uplift 12E of the upper flange 12 in a non-contact manner. The inner circumferential side of the lower face 48D of the cap 48 faces the terrace 12D of the upper flange 12 in a non-contact manner in the axial direction. This structure causes the cap 48 and the upper flange 12 to form a labyrinth to the lubricant 20, thereby preventing the lubricant 20 from being splashed.

The lubricant 20 is present between the rotating body 4 and the stationary body 2 continuously from the first air-liquid interface 122 to the second air-liquid interface 124. The lubricant 20 is present, for example, a space between the inclined surface 44BA and the inner circumferential surface 18A in the radial direction, a space between the cylindrical member 44 and the lower flange 16 in the axial direction, a space between the sleeve 42 and the lower flange 16 in the axial direction, a space between the sleeve 42 and the upper rod 10 in the radial direction, a space between the upper flange 12 and the sleeve 42 in the axial direction, a space between the upper flange 12 and the cylindrical member 44 in the radial direction, and a space between the inclined surface 12AA and the inclined surface 46AA in the radial direction. When the rotating body 4 rotates relative to the stationary body 2, the first, second, third, and fourth dynamic pressure generating grooves 50, 52, 54, and 56 cause the lubricant 20 to produce dynamic pressure. Such dynamic pressure supports the rotating body 4 in the radial direction and in the axial direction in a non-contact manner with the stationary body 2.

The shaft encircling member 40 includes, separately from the gap between the sleeve 42 and the upper rod 10 in the radial direction, a communication passage BP of the lubricant 20 that causes the space between the upper flange 12 and the sleeve 42 in the axial direction and the space between the sleeve 42 and the lower flange 16 in the axial direction to be in communication with each other. For example, the communication passage BP includes a passage provided in the sleeve 42 in the axial direction. The communication passage BP may be provided in the cylindrical member 44 instead of the sleeve 42. The communication passage BP reduces a pressure difference between the space between the upper flange 12 and the sleeve 42 in the axial direction and the space between the sleeve 42 and the lower flange 16 in the axial direction. As a result, a possibility that the lubricant 20 leaks out can be reduced.

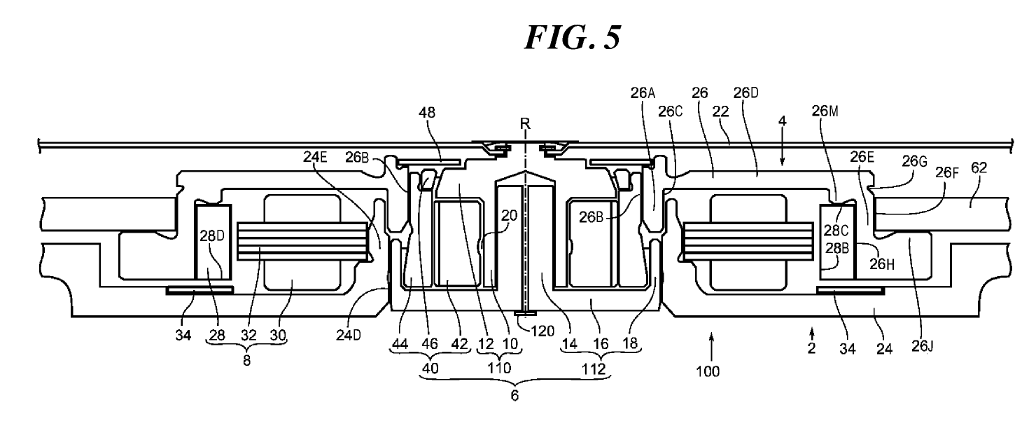

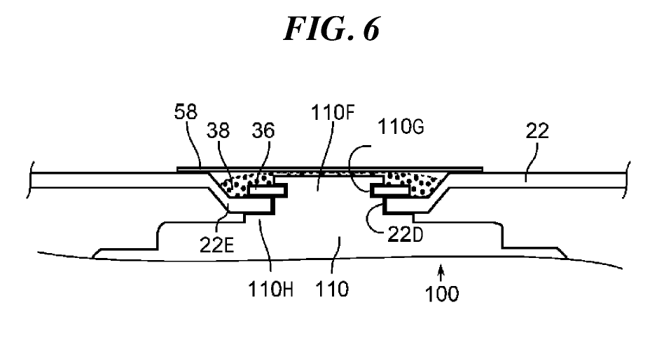

An explanation will now be given of a structure in which the top cover 22 is joined with the upper shaft member 110 with reference to FIGS. 5 and 6. FIG. 5 is an enlarged cross-sectional view illustrating how the top cover 22 is attached to the rotating device in FIG. 2. FIG. 6 is an enlarged cross-sectional view illustrating a joined part between the top cover 22 and the upper shaft member 110 in FIG. 5. FIGS. 5 and 6 are symmetrical along the rotation axis R, and the reference numeral for the same component at the right or left will be omitted in some cases.

The upper shaft member 110 has the cylindrical convexity 110F fitted in the engagement hole 22D of the top cover 22, and the tip of the cylindrical convexity 110F including the circumferential recess 110G protrudes from the top face of the top cover 22. A fastener 36 with a larger diameter than the engagement hole 22D is fitted to the circumferential recess 110G. For example, a U-shaped or C-shaped snap ring (circlip) as the fastener 36 is fitted to the circumferential recess 110G. The seat 110H and the fastener 36 hold therebetween the peripheral edge of the engagement hole 22D, thereby joining the upper shaft member 110 to the top cover 22. A sealant 38 covers across the peripheral edge of the engagement hole 22D, the fastener 36, and the cylindrical convexity 110F. For example, the sealant 38 is formed by applying a curable resin with an ultraviolet curable characteristic to a predetermined area, and emitting ultraviolet rays of a predetermined integrated light quantity to such a resin. The sealant 38 is formed so as not to protrude from the top face of the top cover 22. The top cover 22 has a cover film 58 applied thereto so as to cover the cylindrical convexity 110F. The sealant 38 or the cover film 58 suppresses a leak-in of unclean ambient air from the exterior of the rotating device 100 to the clean space 70. In particular, when the sealant 38 is attached to the side of the engagement hole 22D and a space between the bottom face of the top cover 22 and the seat 110H of the upper shaft member 110, a leak-in of unclean ambient air can be further suppressed.

Next, with reference to FIG. 5 and FIGS. 3, 4 and 6 for the detail, an explanation will be given of an example method of manufacturing the rotating device 100.

(1) The outer circumferential surface 42D of the sleeve 42 is, for example, fitted in and fastened to the inner circumferential surface 44A of the cylindrical member 44. Bonding or press-fit bonding may be applied instead of press-fitting (see FIG. 4).

(2) The first and second dynamic pressure generating grooves 50 and 52 are provided in the inner circumferential surface 42A of the sleeve 42. The third dynamic pressure generating groove 54 and the fourth dynamic pressure generating groove 56 are provided in the upper face 42C of the sleeve 42 and the lower face 42D thereof, respectively.

(3) The upper shaft member 110 having the upper rod 10 and the upper flange 12 already joined together is fitted in the inner circumferential surface 42A of the sleeve 42, and retained therein (see FIG. 4).

(4) The lower shaft member 112 having the lower flange 16, the flange encircling member 18 and the lower rod 14 already joined together is fitted in the retainer hole 10A of the upper rod 10, and is joined therewith. The lower rod 14 is joined with the retainer hole 10A of the upper rod 10 by a combination of press-fitting and bonding. For example, the lower rod 14 is fitted in and fastened to the retainer hole 10A at an area near the lower flange 16, and is bonded and fastened to the retainer hole 10A at an area near the upper flange 12. That is, the bonding area of the lower rod 14 and the retainer hole 10A is located above the press-fit area of those lower rod 14 and retainer hole 10A.

Upon joining the upper rod 10 with the lower rod 14, the sleeve 42 is present in a space where the upper flange 12 and the lower flange 16 face with each other in the axial direction (see FIG. 4).

(5) The ring member 46 is, for example, press-fitted in and fastened to the cylindrical member 44. Bonding or press-fit bonding may be applied instead of press-fitting (see FIG. 4).

(6) The lubricant 20 is filled in the predetermined space between the rotating body 4 and the stationary body 2. The fluid dynamic bearing unit is thus produced (see FIG. 4).

(7) The magnet 28 is fastened to the inner circumferential surface 26H of the second annular part 26E of the hub 26 by, for example, bonding (see FIG. 5).

(8) The outer circumferential surface 44B of the cylindrical member 44 is fastened to the inner circumferential surface 26B of the first annular part 26A of the hub 26 by, for example, press-fitting. Bonding or press-fit bonding may be applied instead of press-fitting (see FIG. 4).

(9) The cap 48 is fastened to the recess 261 of the first annular part 26A by, for example, press-fitting. Bonding or press-fit bonding may be applied instead of press-fitting (see FIG. 4).

(10) The stator core 32 having the coils 30 wound therearound is fastened to the base 24 by, for example, press-fitting. Bonding or Press-fit bonding may be applied instead of press-fitting (see FIG. 5).

(11) The flange encircling member 18 is fitted in the opening 24D of the base 24, and is bonded and fastened thereto (see FIG. 4).

(12) The magnetic recording disk 62 is mounted on the hub 26 (see FIG. 5).

(13) The reader/writer 60 and other components are attached to the base 24.

(14) The cylindrical convexity 110F is fitted in the engagement hole 22D of the top cover 22, and the fastener 36 is attached. The sealant 38 is applied across the peripheral edge of the engagement hole 22D, the fastener 36, and the cylindrical convexity 110F, and the cover film 58 is applied thereabove (see FIG. 6).

(15) The top cover 22 is joined with the base 24. The rotating device 100 is completely manufactured through other processes like a predetermined inspection.

The above-explained manufacturing method of the rotating device 100 and the procedures thereof are merely examples, and the rotating device 100 can be manufactured by other methods and procedures.

An explanation will now be given of an operation of the rotating device 100 employing the above-explained structure. Three-phase drive currents are supplied to the coils 30 in order to rotate the magnetic recording disk 62. The drive currents flowing through the coils 30 produce field magnetic fluxes along the salient poles of the stator core 32. Torque is applied to the magnet 28 by the mutual action of the field magnetic fluxes and the magnetic fluxes of the drive magnetic poles of the magnet 28, and thus the hub 26 and the magnetic recording disk 62 engaged therewith are rotated. At the same time, the voice coil motor 66 causes the swing arm 64 to swing, thereby causing the recording/playing head to move back and forth within the swingable range over the magnetic recording disk 62. The recording/playing head converts magnetic data recorded in the magnetic recording disk 62 into electric signals, and transmits such electric signals to a non-illustrated control substrate, or writes data transmitted from the control substrate in the form of electric signals into the magnetic recording disk 62 as magnetic data.

The rotating device 100 employing the above-explained structure according to the embodiment accomplishes the following advantages.

The shaft and the lower flange 16 are formed together, and the outer circumference of the lower flange 16 having a larger diameter than that of the shaft is joined with the base 24, and thus the joining strength can be increased in comparison with a case in which the shaft is directly joined with the base 24. This results in a decrease of the possibility that the joined part between the base 24 and the shaft breaks down when shock is applied to the rotating device.

Moreover, the lower rod 14, the lower flange 16 and the flange encircling member 18 are formed together, and thus the labor work for assembling can be reduced in comparison with a case in which those members are separately formed and joined together later, thereby improving the work efficiency. Such integral formation suppresses a dimensional error of the lower rod 14, the lower flange 16, and the flange encircling member 18, and thus it is advantageous for downsizing and thinning of the rotating device.

Moreover, the upper rod 10 and the upper flange 12 are formed together, and thus the labor work for assembling can be reduced in comparison with a case in which those members are formed separately and joined together later, thereby improving the work efficiency. Such integral formation suppresses a dimensional error of the upper rod 10 and the upper flange 12, and thus it is advantageous for downsizing and thinning of the rotating device.

The rotating device employs a structure in which the lower flange 16 and the base 24 do not overlap with each other in the axial direction around the peripheral area of the shaft. This facilitates thinning by what corresponds to such non-overlap. Alternatively, when the thickness of the rotating device in the axial direction is restricted, the dimension of a dynamic pressure generating part can be increased in the rotation axis direction.

Since the lower rod 14 is retained in the retainer hole 10A of the upper rod 10, the engaging length thereof can be relatively elongated, and thus the lower rod 14 and the upper rod 10 can be easily aligned coaxially, thereby suppressing an inclination of the lower rod 14 and the upper rod 10. Therefore, an inclination of the lower flange 16 fastened to the lower rod 14 and the upper flange 12 fastened to the upper rod 10 can be suppressed, thereby suppressing an increase of the dimensional error.

The cylindrical convexity 110F of the upper shaft member 110 is engaged and joined with the engagement hole 22D of the top cover 22, and thus it becomes unnecessary to provide a screw hole where a screw is engaged in the end of the shaft. Accordingly, the shaft can have its end formed relatively solid. Hence, a deformation of the upper shaft member 110 when the top cover 22 and the upper shaft member 110 are joined together can be suppressed in comparison with a case in which the end of the shaft is relatively hollow, thereby suppressing the disadvantages inherent to such a deformation.

Moreover, the top cover 22 is provided with the engagement hole 22D, a convexity is provided at the upper end of the upper shaft member 110, and those are engaged with each other. Accordingly, the positioning of the top cover 22 is facilitated, which reduces the labor hours. Alternatively, the bond can be applied to the upper end of the upper shaft member 110 through the engagement hole which has no obstacle and is relatively easy to reach, and thus the bond applying work can be made easy.

### MODIFIED EXAMPLES

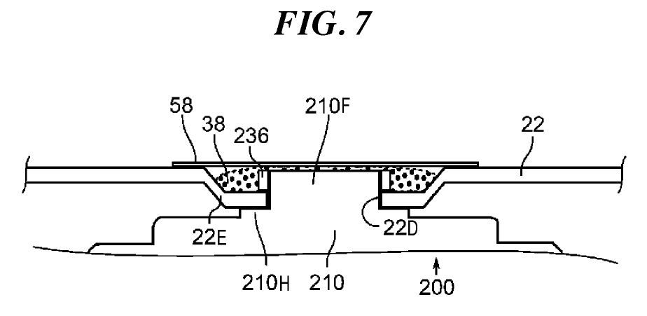

An explanation will now be given of modified examples with reference to FIGS. 7 to 12.

FIG. 7 is an enlarged cross-sectional view illustrating a joined part of the top cover 22 of a rotating device 200 according to a first modified example and an upper shaft member 210 thereof. FIG. 7 corresponds to FIG. 6. The upper shaft member 210 has a cylindrical convexity 210F joined with the top cover 22 by interference fitting to an annular member. The upper shaft member 210 differs from the upper shaft member 110 of the above-explained embodiment only that the cylindrical convexity 210F has a different shape. According to the first modified example, for example, a hollow cylindrical fastener 236 is subjected to interference fitting to and is joined with the side face of the tip of the cylindrical convexity 210F. A fastener in a polygonal shape or in a wave shape in the circumferential direction may be used instead of the hollow cylindrical fastener 236. The fastener 236 is formed of a stainless-steel material like SUS 430 or other metallic materials and formed by cutting and machining, pressing or other processes. The fastener 236 may be placed so as to cover the cylindrical convexity 210F and may have the side face crimped inwardly of the radial direction against the cylindrical convexity 210F by a tool instead of interference-fitting. The cylindrical convexity 210F may have a circumferential recess provided in the side face thereof. Alternatively, threads (screw threads) may be provided on the outer circumferential surface of the cylindrical convexity 210F and the inner circumferential surface of the fastener 236, and those may be engaged with each other. The same is true of the above-explained embodiment that the sealant 38 and the cover film 58 are provided.

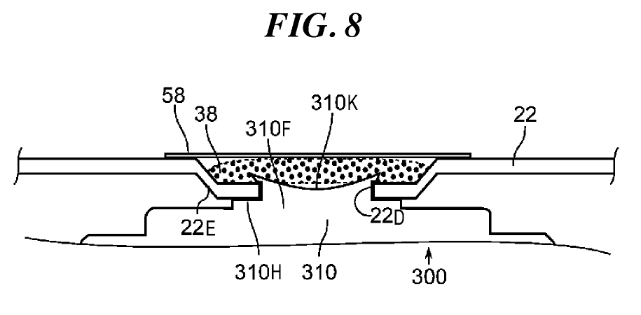

FIG. 8 is an enlarged cross-sectional view illustrating a joined part of the top cover 22 of a rotating device 300 according to a second modified example and an upper shaft member 310 thereof. FIG. 8 corresponds to FIG. 6. A cylindrical convexity 310F of the upper shaft member 310 has an end face crushed, thereby being fastened to the top cover 22. The upper shaft member 310 differs from the upper shaft member 110 of the above-explained embodiment only that the cylindrical convexity 310F has a different shape. According to the second modified example, for example, a recess 310K is provided in the end face of the cylindrical convexity 310F, and the edge of the recess 310K is crushed outwardly of the radial direction, and thus the cylindrical convexity 310F is crimped and joined with the top cover 22. The same is true of the above-explained embodiment that the sealant 38 and the cover film 58 are provided.

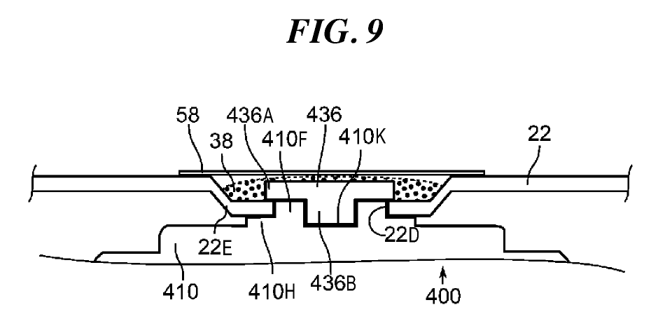

FIG. 9 is an enlarged cross-sectional view illustrating a joined part of the top cover 22 of a rotating device 400 according to a third modified example and an upper shaft member 410 thereof. FIG. 9 corresponds to FIG. 6. The upper shaft member 410 differs from the upper shaft member 110 of the above-explained embodiment only that a cylindrical convexity 410F has a different shape. A recess 410K is provided in the end face of the cylindrical convexity 410F, and a fastener 436 is press-fitted to the recess 410K, thereby being joined with the top cover 22. For example, the fastener 436 includes a flange 436A in a disc shape and a cylindrical protrusion 436B running downwardly from the lower end of the flange 436A and press-fitted in the recess 410K. The flange 436A of the fastener 436 has a larger outer diameter than the internal diameter of the engagement hole 22D of the top cover 22. A peripheral edge of the engagement hole 22D of the top cover 22 is held between the flange 436A and a seat 410H in the axial direction. The fastener 436 is formed of a ferrous material like SUS 430, and formed by cutting and machining, and pressing, etc. The same is true of the above-explained embodiment that the sealant 38 and the cover film 58 are provided.

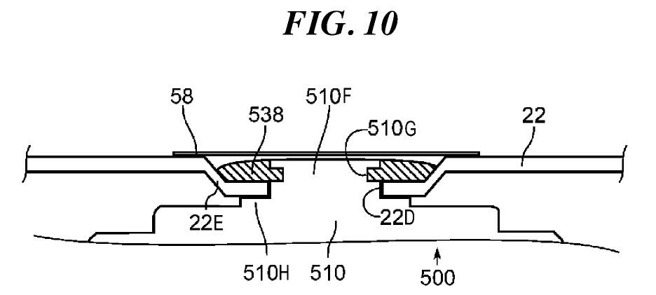

FIG. 10 is an enlarged cross-sectional view illustrating a joined part of the top cover 22 of a rotating device 500 according to a fourth modified example and an upper shaft member 510 thereof. FIG. 10 corresponds to FIG. 6. The upper shaft member 510 has a cylindrical convexity 510F joined with the top cover 22 by bonding thereto. The upper shaft member 510 differs from the upper shaft member 110 of the above-explained embodiment only that the cylindrical convexity 510F has a different shape. A circumferential recess 510G is provided in the side face of the cylindrical convexity 510F, and a UV-curable resin 538 is applied across the cylindrical convexity 510F including the peripheral edge of the engagement hole 22D and the circumferential recess 510G. By applying the UV-curable resin 538 to the circumferential recess 510G, the bonding strength can be enhanced. The labor work is facilitated since no fastener is used. The same is true of the above-explained embodiment that the cover film 58 is provided.

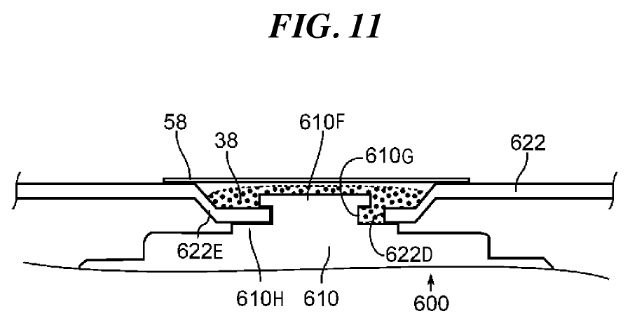

FIG. 11 is an enlarged cross-sectional view illustrating a joined part of a top cover 622 of a rotating device 600 according to a fifth modified example and an upper shaft member 610 thereof. FIG. 11 corresponds to FIG. 6. The upper shaft member 610 has a cylindrical convexity 610F joined with the top cover 622 by causing the edge of the top cover 622 to be fitted in a recess provided in the cylindrical convexity 610F. The upper shaft member 610 differs from the upper shaft member 110 of the above-explained embodiment only that the cylindrical convexity 610F has a different shape. The top cover 622 differs from the top cover 22 of the above-explained embodiment only that an engagement hole 622D has a different shape. A circumferential recess 610G is provided in the side face of the cylindrical convexity 610F. The circumferential recess 610G has a slightly larger aperture dimension in the axial direction than the thickness dimension of the top cover 622 in the axial direction. The engagement hole 622D has a small-diameter opening in a substantially circular shape and slightly larger than the diameter of the circumferential recess 610G and a large-diameter opening in a substantially circular shape and slightly larger than the diameter of the cylindrical convexity 610F partially overlapping with each other. The tip of the cylindrical convexity 610F passes all the way through the large-diameter opening, and protrudes from the top face of the top cover 622. The top cover 622 is moved to the right in FIG. 11, and the edge of the small-diameter opening is fitted into the circumferential recess 610G, thereby joining the upper shaft member 610 with the top cover 622. The dimension of the cylindrical convexity 610F in the axial direction can be reduced by what corresponds to the lack of a fastener, and thus the dimension of the rotating device 600 in the axial direction can be reduced. Alternatively, the labor work is facilitated since no fastener is attached. The same is true of the above-explained embodiment that the sealant 38 and the cover seat 58 are provided.

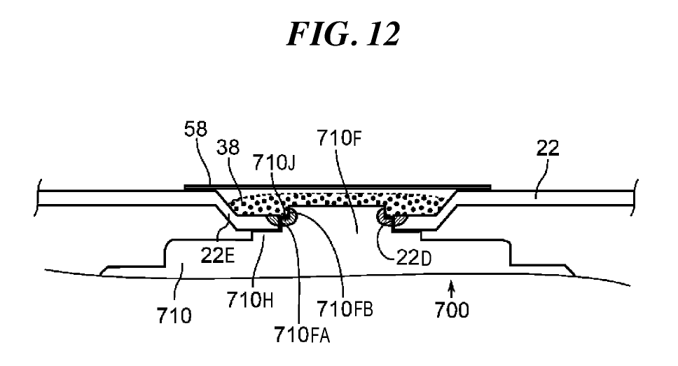

FIG. 12 is an enlarged cross-sectional view illustrating a joined part of the top cover 22 of a rotating device 700 according to a sixth modified example and an upper shaft member 710 thereof. FIG. 12 corresponds to FIG. 6. The upper shaft member 710 has a cylindrical convexity 710F joined with the top cover 22 by welding. The upper shaft member 710 differs from the upper shaft member 110 of the above-explained embodiment only that the cylindrical convexity 710F has a different shape. Provided in the side face of the cylindrical convexity 710F are a large-diameter part 710FA protruding upwardly of the axial direction from a seat 710H, and a small-diameter part 710FB protruding upwardly of the axial direction from the upper face of the large-diameter part 710FA. The small-diameter part 710FB has an outer diameter smaller than the outer diameter of the large-diameter part 710FA. The large-diameter part 710FA has an upper end located below the peripheral edge of the engagement hole 22D of the top cover 22. For example, laser beam like YAG laser is emitted across the edge of the engagement hole 22D, the large-diameter part 710FA, and the small-diameter part 710FB while moving in the circumferential direction, thereby forming a fused joined part 710J (hatched area). That is, the fused joined part 710J includes the inner circumferential side face of the peripheral edge of the engagement hole 22D, the upper face thereof, the upper end face of the large-diameter part 710FA, and the outer circumferential side face of the small-diameter part 710FB. Since the fused joined part includes the side faces of the joining-target members and the end faces thereof, the variability of the joining strength can be reduced. The same is true of the above-explained embodiment that the sealant 38 and the cover film 58 are provided.

The explanation was given of the structures of the rotating devices according to the embodiment and the modified examples thereof, and the operations thereof. Those embodiment and the modified examples are merely examples, and it should be understood for those skilled in the art that the combination of the respective components permits various modifications, and such modifications are within the scope and spirit of the present invention.

In the above-explained embodiment, the explanation was given of the example case in which the lower shaft member is directly attached to the base, but the present invention is not limited to this case. For example, a brushless motor including a rotating body and a stationary body may be formed separately, and such a brushless motor may be attached to a chassis.

In the above-explained embodiment, the explanation was given of the example case (a so-called outer rotor structure) in which the stator core is encircled by the magnet, but the present invention is not limited to this case. For example, a structure (a so-called inner rotor structure) in which the magnet is encircled by the stator core may be employed.

In the above-explained embodiment, although a part of the cylindrical convexity of the upper shaft member protrudes from the top face of the top cover, the present invention is not limited to this case. For example, a structure may be employed in which the upper end face of the cylindrical convexity is bonded and fastened to the bottom face of the top cover.

What is claimed is:

1. A rotating device comprising:
a base comprising a peripheral wall provided at a peripheral edge of the base;
a top cover fastened to the peripheral wall;
an axial body having one end fixedly provided to the base, and having another end joined with the top cover;
a bearing body which retains thereinside the axial body and which is supported in a freely rotatable manner relative to the base;
a radial dynamic pressure generating groove provided in either one of surfaces of the axial body and the bearing body facing with each other in a radial direction;
a lubricating medium present in a space between the axial body and the bearing body;
a lower flange provided on a side face of the axial body at the one-end side, and extending outwardly of the radial direction; and
an upper flange provided on a side face of the axial body at the another-end side, and extending outwardly of the radial direction,
the bearing body being placed in a space between the upper flange and the lower flange in an axial direction, and
the axial body comprising a lower rod to which the lower flange is fastened, and an upper rod which encircles the lower rod and to which the upper flange is fastened.

2. The rotating device according to claim 1, wherein the lower flange is formed together with the lower rod as a single piece.

3. The rotating device according to claim 1, wherein the upper flange is formed together with the upper rod as a single piece.

4. The rotating device according to claim 1, further comprising a gas reservoir provided in a space between the upper rod and the lower rod in the axial direction,
wherein the lower rod is provided with a through-hole that is in communication with the gas reservoir.

5. The rotating device according to claim 1, further comprising a flange encircling member which extends from an outer circumference of the lower flange toward the upper flange in the axial direction, encircles the bearing body with a gap, and is formed integrally with the lower flange,
wherein an encircling-member-side capillary seal which suppresses a leak-out of the lubricating medium is formed in a gap between an inner circumferential surface of the flange encircling member and an outer circumferential surface of the bearing body in the radial direction.

6. The rotating device according to claim 1, wherein
the bearing body comprises a cylindrical member that includes a flange-side inner circumferential surface facing with an outer circumferential surface of the upper flange in the radial direction, and
a flange-side capillary seal that suppresses a leak-out of the lubricating medium is formed in a gap in the radial direction between the outer circumferential surface of the upper flange and the flange-side inner circumferential surface.

7. The rotating device according to claim 1, further comprising a thrust dynamic pressure generating groove which is provided in at least either one of any of surfaces of the upper flange and the bearing body facing with each other in the axial direction and any faces of the lower flange and the bearing body facing with each other in the axial direction.

8. A rotating device comprising:
a base comprising a peripheral wall provided at a peripheral edge of the base;
a top cover fastened to the peripheral wall;
an axial body having one end fixedly provided to the base, and having another end joined with the top cover;
a bearing body which retains thereinside the axial body and which is supported in a freely rotatable manner relative to the base;
a radial dynamic pressure generating groove provided in either one of surfaces of the axial body and the bearing body facing with each other in a radial direction;
a lubricating medium present in a space between the axial body and the bearing body;
a lower flange provided on a side face of the axial body at the one-end side, and extending outwardly of the radial direction; and
an upper flange provided on a side face of the axial body at the another-end side, and extending outwardly of the radial direction,
the bearing body being placed in a space between the upper flange and the lower flange in an axial direction,
the axial body comprising a lower rod to which the lower flange is fastened, and an upper rod which encircles the lower rod and to which the upper flange is fastened, and
the axial body further comprising an axial-body convexity engaged with an engagement hole provided in the top cover.

9. The rotating device according to claim 8, wherein the lower flange is formed together with the lower rod as a single piece.

10. The rotating device according to claim 8, wherein the upper flange is formed together with the upper rod as a single piece.

11. The rotating device according to claim 8, further comprising a gas reservoir provided in a space between the upper rod and the lower rod in the axial direction,
wherein the lower rod is provided with a through-hole that is in communication with the gas reservoir.

12. The rotating device according to claim 8, further comprising a flange encircling member which extends from an outer circumference of the lower flange toward the upper flange in the axial direction, encircles the bearing body with a gap, and is formed integrally with the lower flange,
wherein an encircling-member-side capillary seal which suppresses a leak-out of the lubricating medium is formed in a gap between an inner circumferential surface of the flange encircling member and an outer circumferential surface of the bearing body in the radial direction.

13. The rotating device according to claim 8, wherein
the bearing body comprises a cylindrical member that includes a flange-side inner circumferential surface facing with an outer circumferential surface of the upper flange in the radial direction, and
a flange-side capillary seal that suppresses a leak-out of the lubricating medium is formed in a gap in the radial direction between the outer circumferential surface of the upper flange and the flange-side inner circumferential surface.

14. The rotating device according to claim 8, further comprising a thrust dynamic pressure generating groove which is provided in at least either one of any of surfaces of the upper flange and the bearing body facing with each other in the axial direction and any faces of the lower flange and the bearing body facing with each other in the axial direction.

15. A rotating device comprising:
a base comprising a peripheral wall provided at a peripheral edge of the base;
a top cover fastened to the peripheral wall;
an axial body having one end fixedly provided to the base, and having another end joined with the top cover;
a bearing body which retains thereinside the axial body and which is supported in a freely rotatable manner relative to the base;
a radial dynamic pressure generating groove provided in either one of surfaces of the axial body and the bearing body facing with each other in a radial direction; and
a lubricating medium present in a space between the axial body and the bearing body,
the axial body comprising an axial-body convexity engaged with an engagement hole provided in the top cover.

16. The rotating device according to claim 15, wherein the axial-body convexity is fastened to the top cover by joining a fastener to the axial-body convexity.

17. The rotating device according to claim 15, wherein an annular recess is provided in an outer circumferential surface of the axial-body convexity.

18. The rotating device according to claim 15, wherein the axial-body convexity is fastened to the top cover by bonding, brazing, caulking, crimping, press-fitting or welding.

19. The rotating device according to claim 15, further comprising a sealant that is applied across the axial-body convexity and the top cover.

20. The rotating device according to claim 19, further comprising a film that covers the sealant.
